(19) United States
(12) Patent Application Publication
(10) Pub. No.: US 2011/0125502 A1
(43) Pub. Date: May 26, 2011

(54) Method of putting identification codes in a document

(75) Inventors: Mardianto Soebagio Hadiputro, Taipei (TW); Kun-Yi Hua, Taipei (TW); Hwa-Pey Wang, Taipei (TW); Chih-Kang Yang, Taipei (TW); Kuo-Ping Yang, Taipei (TW)

(73) Assignee: KUO-PING YANG, TAIPEI (TW)

(21) Appl. No.: 12/923,012

(22) Filed: Aug. 30, 2010

(30) Foreign Application Priority Data
Nov. 24, 2009 (TW) 098139977

(51) Int. Cl. G10L 21/00

(52) U.S. Cl. 704/270; 704/E21.001

(57) ABSTRACT

A method of putting identification codes in a document is disclosed. The method adds a speech-purpose print code in a document such that an OID pen can emit sound after the OID pen reads the speech-purpose print code. The software program first acquires the position of each word in the document and then automatically puts a speech-purpose print code corresponding to each word in the position of each word so that a user can rapidly generate a document with speech-purpose codes.

### BACKGROUND OF THE INVENTION

1. Field of the Invention

The present invention relates to a method of putting identification codes in a document. The document may be, for example, a teaching material for learning a language.

2. Description of the Related Art

Using an OID Pen to read print codes printed on paper to acquire information is a prior art.

However, using an OID Pen to learn language is an invention of the recent ten years. The primary procedure is to print one or more print codes on a book or paper. Print codes are relatively small spotcodes (usually 2D barcodes). A magnifier is required to clearly view them. When a user holds the OID Pen and makes it contact the book, the OID Pen reads the print codes. The OID Pen will then emit corresponding sounds with the determination of the software program of the OID pen.

Currently, when the user uses this kind of OID Pen for learning language, it has to be associated with teaching materials printed by publishers. The user cannot print teaching materials at home himself/herself. Therefore, when the user buys an OID pen, he/she can only buy books or teaching materials from an original manufacturer. Because the user cannot print the books or the teaching materials himself/herself, coming into the possession of such books or teaching materials can be very expensive.

Special development software is necessary to make this kind of teaching materials with specially printed print codes. Even if the user can obtain the development software, it is not easy to use it. The difficulty arises from the fact that when the user inputs a word or inserts a picture, he/she has to circumscribe the area of a print code. If the user inputs 100 words, the user has to circumscribe the areas of 100 “print codes”. This is very laborious. In addition, even though the user would like to spend so much time making special teaching materials and print them with the printer at home, there is still a further problem. The words are usually printed in dark colors (such as black and dark blue). Black ink or toner contained in the printed words will cause the OID Pen to fail to read the print codes because the print codes are printed in black ink or toner, too.

Therefore, it is desirable to enable a user, such as a teacher, to print teaching materials at home by himself/herself. For example, he or she can download an article from the internet and use a printer at home, at school, or in the office to print it as a teaching material.

### SUMMARY OF THE INVENTION

A primary object of the present invention is to provide a user with a method of rapidly generating a document with speech-purpose codes that not only the manufacturer which sells teaching materials but also a general user such as an individual, a teacher, and parents can easily use.

To achieve the abovementioned objects, a method of putting identification codes in a document of the present invention adds a speech-purpose print code in a document so that an OID pen can emit sound after the OID pen reads the speech-purpose print code. The method of the present invention comprises the following steps:

receiving input of at least one word in the document;

searching for a voice code corresponding to the at least one word;

acquiring a corresponding word position of the at least one word in the document; and

putting the speech-purpose print code in the word position to generate a document with speech-purpose codes, wherein the speech-purpose print code is generated according to the voice code;

whereby after the document with speech-purpose codes is printed, the OID Pen can read the speech-purpose print code in the document.

According to the embodiments, at least two function print codes can be further put in the document may, so as to perform a function of memory and a function of emitting the sounds of a plurality of words. In addition, in order to increase the efficiency of reading a speech-purpose print code with the OID Pen, the K value (the amount of black) of words in the document is eliminated when it is necessary.

### BRIEF DESCRIPTION OF THE DRAWINGS

FIG. 1 is an environmental schematic drawing according to a first embodiment of the present invention.

FIG. 2 is an embodiment of a word-and-voice-code database of the present invention.

FIG. 3 is an environmental schematic drawing according to a second embodiment of the present invention.

FIG. 4 is a flowchart of the present invention.

FIG. 5 is an embodiment of an editing interface of the present invention.

FIG. 6 is an embodiment of the editing interface of the present invention and shows a document with speech-purpose codes.

FIG. 7 is an embodiment of the printed document with speech-purpose codes of the present invention.

FIG. 8 is a schematic drawing showing an optical index pen of the present invention being used.

FIG. 9 is the procedure for eliminating the K value of words in a document of the present invention.

FIG. 10 is another embodiment of the printed document with speech-purpose codes of the present invention. The speech-purpose print codes are printed below the corresponding words.

### DETAILED DESCRIPTION OF THE PREFERRED EMBODIMENT

The advantages and innovative features of the invention will become more apparent from the following detailed description when taken in conjunction with the accompanying drawings.

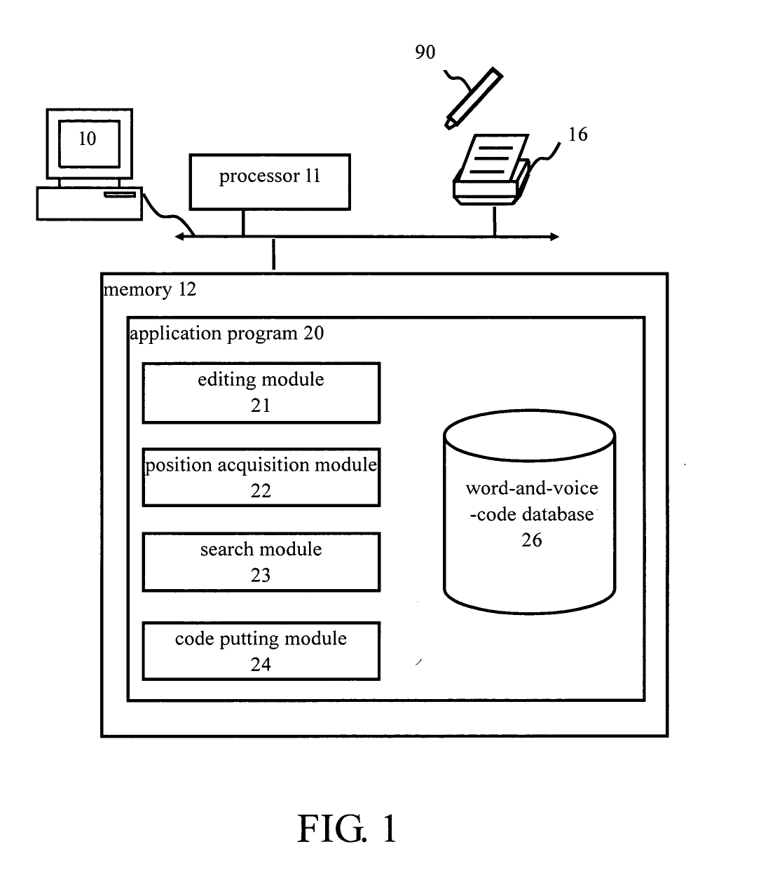

Please refer to FIG. 1, which illustrates an environmental schematic drawing according to a first embodiment of the present invention, for the following paragraphs.

A user can utilize a personal computer 10 to execute the method of the present invention. The computer 10 mainly comprises a processor 11 and a memory 12. The memory 12 stores an application program 20. In the present invention, the processor 11 executes the application program 20 so as to generate and perform the steps of the present invention. The application program 20 mainly comprises an editing module 21, a position acquisition module 22, a search module 23, a code putting module 24, and a word-and-voice-code database 26.

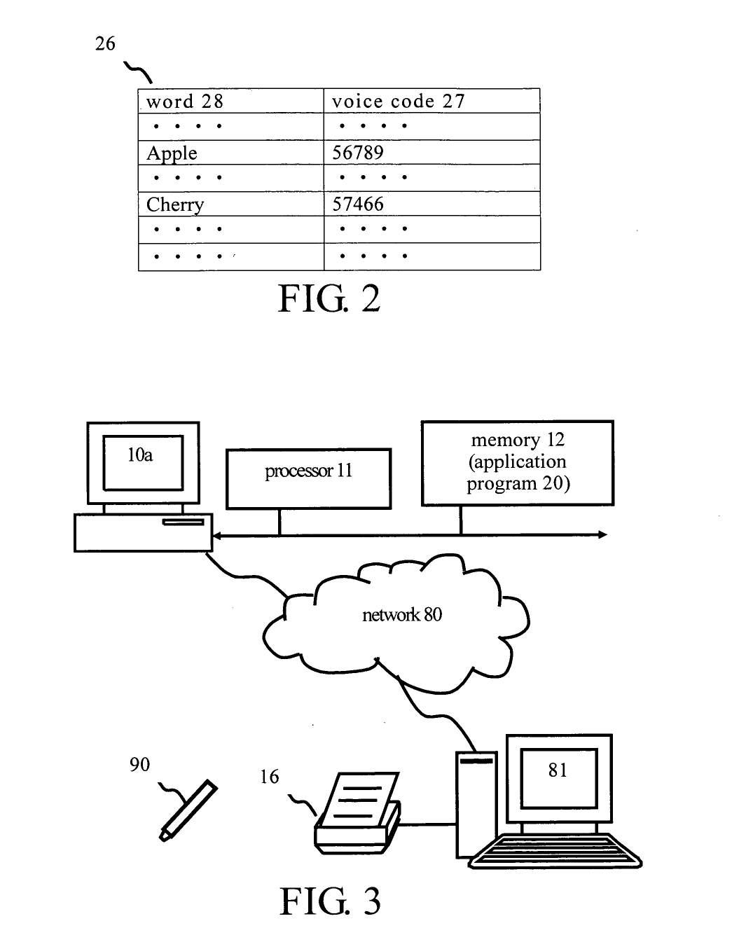

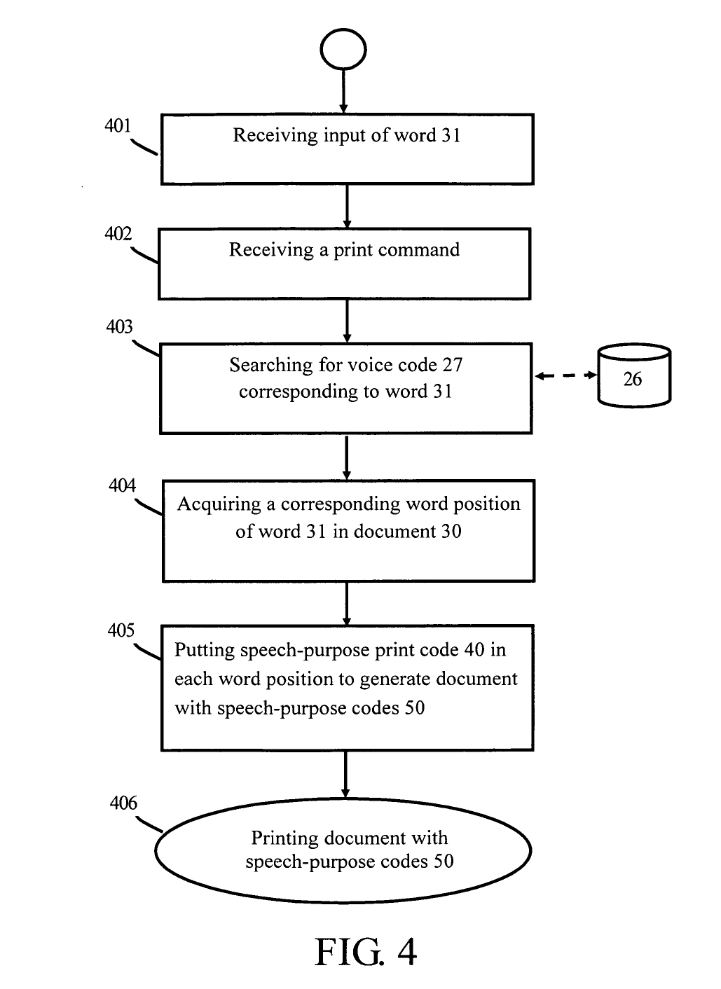

Please refer to FIG. 2. The word-and-voice-code database 26 primarily stores two forms of data: word 28 data and corresponding voice code 27 data. The function of each module will be described later, in the illustration of the flow chart (FIG. 4) of the present invention. The computer 10 is connected to a printer 16 via either a wired connection or a wireless connection. The printer 16 is used for printing documents. Its printout can be read by an OID (OID: Optical Index/Optical Identification; please refer to http://www.giga.com.tw/english/productpen.htm, for example) pen 90. Since the hardware of the OID Pen 90 is a known device, there is no need for further description.

FIG. 3 illustrates an environmental schematic drawing according to a second embodiment of the present invention. FIG. 2 illustrates an environmental schematic drawing according to a second embodiment of the present invention. The user utilizes a near-end computer 81 to connect to a computer 10a (such as a network server) via a network 80 (such as the internet), such that the near-end computer 81 can use the application program 20 of the network server 10a. In the second embodiment, the printer 16 is connected to the near-end computer 81 via either a wired connection or a wireless connection. The point of these two different embodiments is that the user can utilize the computer to execute the application program 20, and then utilize the printer 16 to print documents. The printed documents can be read by the OID Pen 90.

Please refer to FIG. 4, which is the flowchart of the present invention. Please also refer to FIGS. 1-3 and FIGS. 5-6 to understand the present invention.

### Step 401:

Receiving input of at least one word 31 in a document 30.

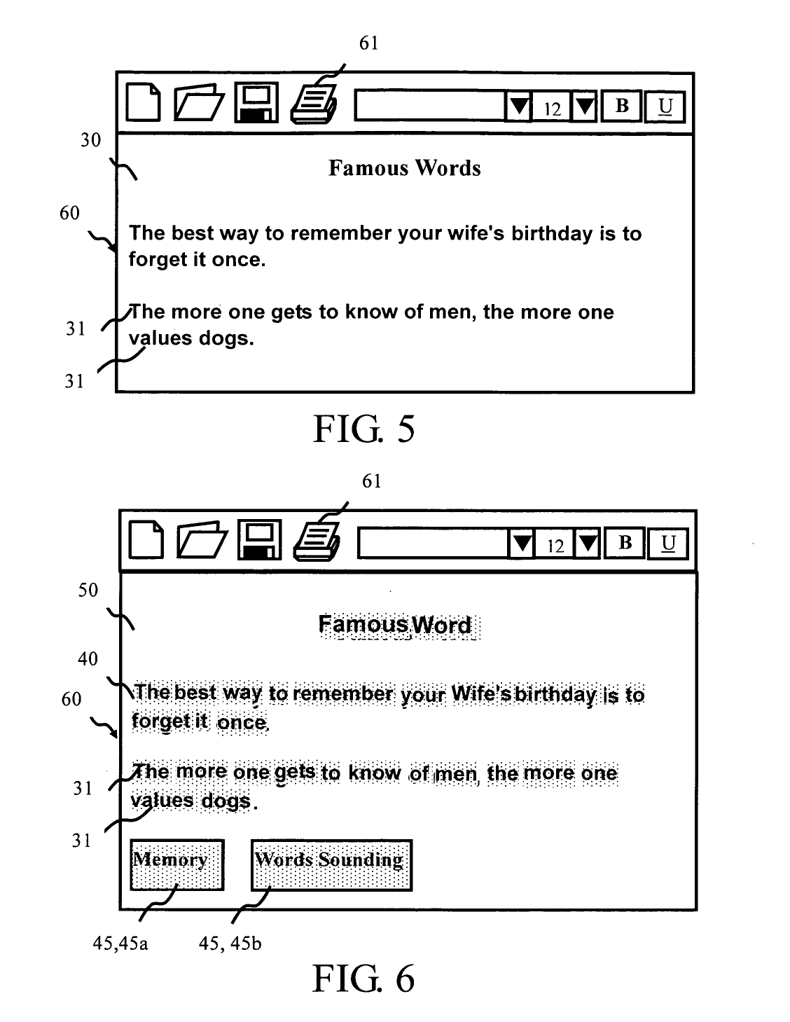

Please refer to FIG. 5. After the application program 20 is executed, the user can edit a document 30 in an editing interface 60. In this embodiment, a plurality of words 31 are shown. Of course, the words can be edited by other word editing software first and then pasted into the editing interface 60.

The editing interface 60 may have many function buttons. A print clicking button 61 is the one that is especially related to the present invention. Step 401 is performed by the editing module 21.

### Step 402:

Receiving a print command.

For example, the user clicks the print clicking button 61.

### Step 403:

Searching for a voice code 27 corresponding to the at least one word 31.

The search module 23 searches for a voice code 27 corresponding to each word 31 in the word-and-voice-code database 26. For example, the document 30 has the plurality of words 31 of “Famous Words”, “The best . . . once”, and “The more . . . more one values dogs”. The search module 23 searches for a voice code 27 corresponding to each word 31.

Take English for example. The word-and-voice-code database 26 can store 5000 frequently used English words and voice codes 27 respectively corresponding to the English words. Each voice code 27 can be stored in a form of numbers.

### Step 404:

The position acquisition module 22 acquires a corresponding word position of the at least one word 31 in the document 30.

The position acquisition module 22 acquires the word position of the plurality of words 31, “Famous Words . . . the more one values dogs”. For example, the word position of each word 31 is defined by the left-top coordinate, left-bottom coordinate, right-top coordinate, and right-bottom coordinate of the word. Since the process of getting the word position of a word is well known to those of reasonable skill in the art, there is no need for further description.

### Step 405:

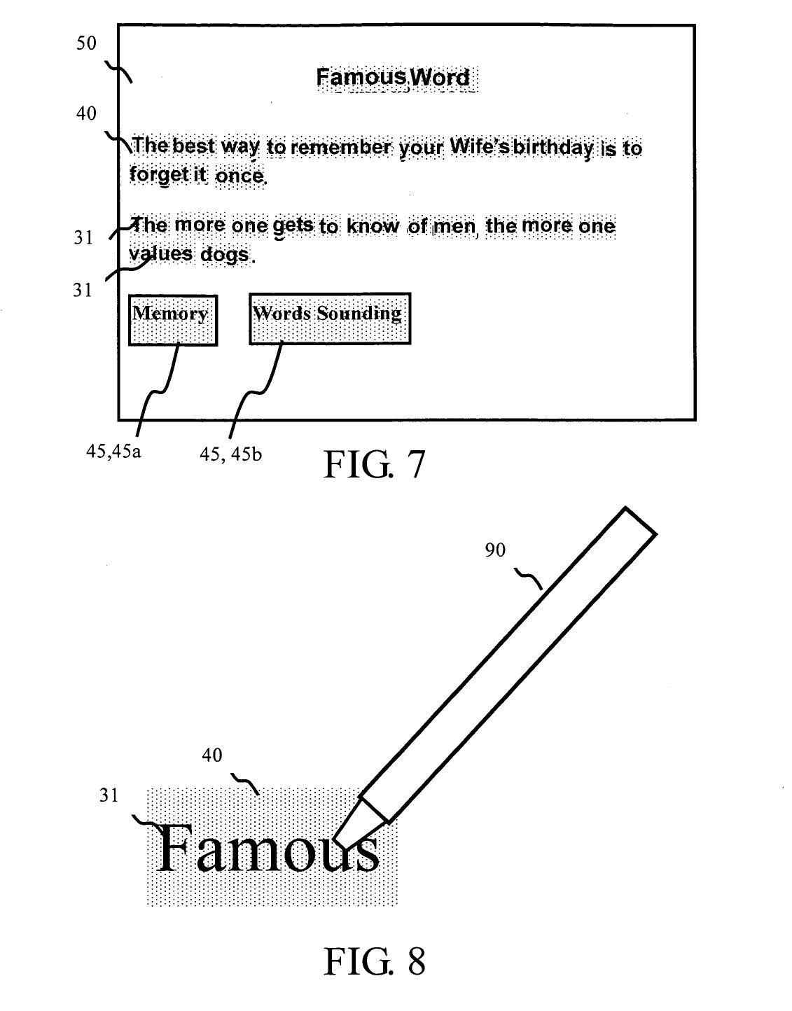

The code putting module 24 puts a speech-purpose print code 40 in each word position to generate a document with speech-purpose codes 50. As shown in FIG. 6, each speech-purpose print code 40 is generated according to a voice code 27. Please refer to FIG. 7. A speech-purpose print code 40 is a relatively small spotcode (such as a 2D barcode representing “00053”). Basically, a magnifier is required to clearly view the speech-purpose print code 40.

In this embodiment, the document with speech-purpose codes 50 further comprises two function print codes 45: a memory start function print code 45a and a plurality of words sounding function print code 45b.

### Step 406:

Printing the document with speech-purpose codes 50.

As shown in FIG. 7, the printer 16 prints the document with speech-purpose codes 50.

It should be noted that in step 405, the document with speech-purpose codes 50 is not necessarily shown on the screen (FIG. 6). When the user clicks the print clicking button 61, the position acquisition module 22 and the code putting module 24 of the application program 20 begin to execute. After the application program 20 transmits the document with speech-purpose codes 50 to the printer 16, the printer 16 prints the document with speech-purpose codes 50.

Please refer to FIG. 8. The user holds the OID Pen 90 and makes it contact, for example, the area “Famous”. The OID Pen 90 reads the speech-purpose print code 40 corresponding to “Famous”. The OID Pen 90 can then emit the sound of “Famous” (a common OID Pen 90 has a speaker and stores the sounds of words).

Another feature of the present invention is that the OID Pen 90 can sequentially emit the corresponding sounds of a plurality of words. Please refer to FIG. 7. For example, the user first holds the OID Pen 90 and makes it contact the memory start function print code 45a, so as to start the memory function of the OID Pen 90. He/she then holds the OID pen 90 and sequentially makes it contact the following words 31: “The best way to remember your wife's birthday is to forget it once”. Finally, he/she holds the OID Pen 90 and makes it contact the plurality of words sounding function print code 45b. The OID Pen 90 will then emit the corresponding sounds of the plurality of words. The software program of the OID Pen 90 is not the primary issue of the present invention, and so is not elaborated upon.

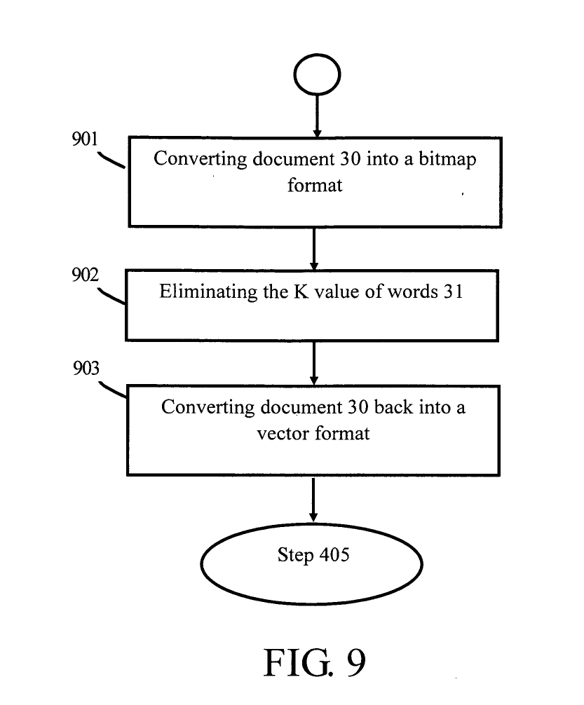

In addition, generally, the words 31 are printed in black ink or toner. (In addition to black, generally, the words 31 can also be printed in dark colors such as dark blue or dark green, and dark colors also contain black ink or toner.) Because currently a speech-purpose print code 40 is usually black so as to be read by the OID Pen 90, if the words 31 in the document with the speech-purpose codes 50 contain black ink or toner, the black ink or toner will cause the OID Pen 90 to fail to read the speech-purpose print code 40. Therefore, please refer to FIG. 9 regarding the procedure for eliminating the K value (i.e., the amount of black) of the words 31 in the document 30.

### Step 901:

Converting the document 30 into a bitmap format so that the words 31 in the document 30 are converted into a bitmap format.

### Step 902:

Eliminating the K value of the words 31. When a printer prints, it prints in CMYK (C: cyan; M: magenta; Y: yellow; K: black). For example, the words 31 are originally black. In this step, the black part is replaced by the three colors CMY; that is to say, simulating black with CMY makes the user think the words 31 are black. (During the printing process, every dot is very tiny. People perceive a combination or a partial combination of the three colors CMY, or printed dots very close to each other, as a dark color.) This is the reason to convert the document 30 into a bitmap format in step 901. The principle of printing is not the primary issue of the present invention, and so it is not elaborated upon.

### Step 903:

Converting the document 30 back into a vector format.

Step 903 is performed, followed by step 405.

The above steps 901˜903 is preferably performed after step 402.

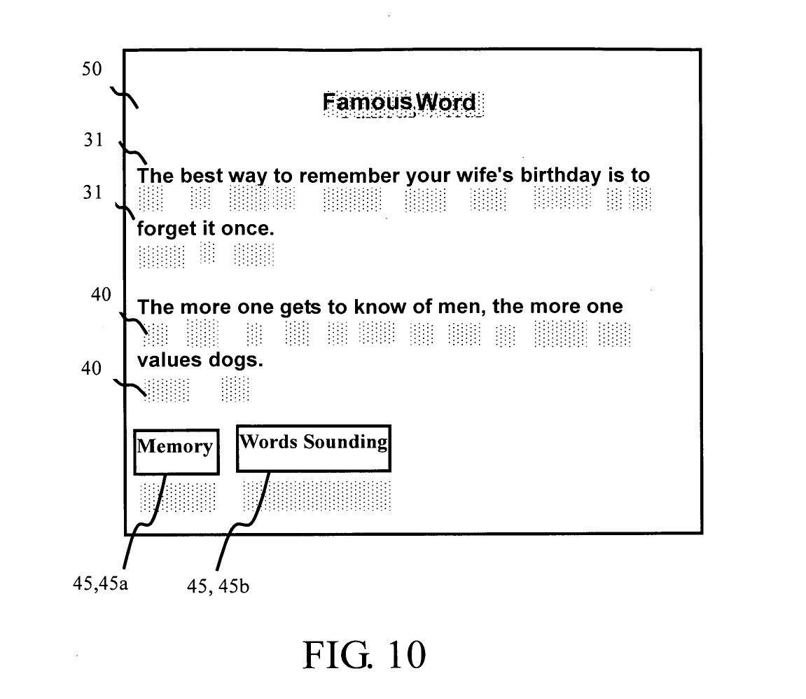

Steps 90˜903 are not always necessary. For example, when the words 31 in the document 30 are not in dark colors (such as white, light yellow, and light blue), or when the K value of the words 31 is small and thus will not cause the OID Pen 90 to fail to read speech-purpose print codes 40, steps 901˜903 are not necessary. Moreover, for example, as shown in FIG. 10, the speech-purpose print codes 40 are arranged below the words 31. Because there is no interference from the words 31, steps 901˜903 are not necessary.

It is noted that the above-mentioned embodiments are only for illustration. It is intended that the present invention cover modifications and variations of this invention provided they fall within the scope of the following claims and their equivalents. Therefore, it will be apparent to those skilled in the art that various modifications and variations can be made to the structure of the present invention without departing from the scope or spirit of the invention.

What is claimed is:

1. A method of putting identification codes in a document, which adds a speech-purpose print code in a document so that an OID pen can emit sound after the OID pen reads the speech-purpose print code, the method comprising the following steps:
receiving input of at least one word in the document;
searching for a voice code corresponding to the at least one word;
acquiring a corresponding word position of the at least one word in the document; and
putting the speech-purpose print code in the word position to generate a document with speech-purpose codes, wherein the speech-purpose print code is generated according to the voice code;
whereby after the document with speech-purpose codes is printed, the OID Pen can read the speech-purpose print code in the document.

2. The method of putting identification codes in a document as claimed in claim 1, wherein the step of searching for a voice code corresponding to the at least one word is based on a search in a word-and-voice-code database, the word-and-voice-code database storing a plurality of words and the voice code corresponding to each of the plurality of words.

3. The method of putting identification codes in a document as claimed in claim 2, wherein the method further comprises the following step: putting at least two function print codes in the document.

4. The method of putting identification codes in a document as claimed in claim 3, wherein the at least two function print codes are a memory start function print code and a plurality of words sounding function print code, and the OID Pen emits sound which has been emitted and recorded via the memory start function print code and the plurality of words sounding function print code.

5. The method of putting identification codes in a document as claimed in claim 4, wherein after the document with speech-purpose codes is printed, the speech-purpose print code substantially covers the corresponding at least one word.

6. The method of putting identification codes in a document as claimed in claim 5, wherein the method further comprises the following step: eliminating a K value of the at least one word.

7. The method of putting identification codes in a document as claimed in claim 6, wherein the method further comprises the following step prior to the step of eliminating a K value of the at least one word: converting the document into a bitmap format.

8. The method of putting identification codes in a document as claimed in claim 7, wherein the method further comprises the following step after the step of eliminating a K value of the at least one word: converting the document into a vector format.

9. The method of putting identification codes in a document as claimed in claim 4, wherein after the document with speech-purpose codes is printed, the speech-purpose print code is printed below the corresponding at least one word.

10. The method of putting identification codes in a document as claimed in claim 1, wherein after the document with speech-purpose codes is printed, the speech-purpose print code substantially covers the corresponding at least one word.

11. The method of putting identification codes in a document as claimed in claim 10, wherein the method further comprises the following step: eliminating a K value of the at least one word.

12. The method of putting identification codes in a document as claimed in claim 11, wherein the method further comprises the following step prior to the step of eliminating a K value of the at least one word: converting the document into a bitmap format.

13. The method of putting identification codes in a document as claimed in claim 12, wherein the method further comprises the following step after the step of eliminating a K value of the at least one word: converting the document into a vector format.
